(19) United States
(12) Patent Application Publication
(10) Pub. No.: US 2005/0173825 A1
(43) Pub. Date: Aug. 11, 2005

(54) Printing process

(76) Inventors: Yevgeniy I. Globus, Littleton, MA (US); Mark A. Jozokos, Pelham, NH (US); John L. Netta, Newark, DE (US); George Martin Pruce, Glastonbury, CT (US); Sundar Kilnagar Venkataraman, Vienna, WV (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/039,438

(22) Filed: Jan. 19, 2005

Related U.S. Application Data
(60) Provisional application No. 60/539,044, filed on Jan. 23, 2004.

(51) Int. Cl. C04B 41/00

(52) U.S. Cl. 264/132

(57) ABSTRACT

The present invention relates to the making of perfluoropolymer articles ink-printable, by incorporating into said fluoropolymer prior to printing, at least 10 wt % of inorganic particulate filler, and preferably an effective amount of hydrocarbon polymer to disperse the filler in the perfluoropolymer.

### BACKGROUND OF THE INVENTION

1. Field of the Invention

This invention relates to the formation of a printable fluoropolymer surface.

2. Description of Related Art

Perfluoropolymer surfaces are not printable, because printing inks do not adhere to the surface. Application of the printing ink may form a temporary printed image on the surface, which is easily smeared or wiped off. U.S. Pat. No. 4,427,877 discloses the making of perfluoropolymer surfaces printable by printing ink by incorporating into the perfluoropolymer from 2-20 vol % of particulate filler, mentioning glass fiber, calcined clay and glass beads, preferably 7-15 vol %, with the suitable amount for many fillers being 5 to 15 wt %. The filler is required to have at least two dimensions be at least 1 micrometer, preferably at least 2 micrometers, average size to cause micro-roughening of the extruded perfluoropolymer surface which is sufficient to make the surface printable. Unfortunately, as the amount of these fillers increase in the perfluoropolymer, it becomes more difficult to extrude the resultant composition, because of the increase in melt viscosity imparted to the resultant composition by the filler.

### BRIEF SUMMARY OF THE INVENTION

The present invention provides for printable perfluoropolymer, i.e. printable with printing ink to provide a durable printed image on the surface of the perfluoropolymer.

Thus, the present invention can be defined as a process for printing on the surface of an article melt-fabricated, preferably by extrusion, from perfluoropolymer, comprising incorporating into said perfluoropolymer prior to said printing about 10 to 60 wt % of inorganic particulate filler. After the filler is incorporated into the perfluoropolymer and fabricated into the desired article, the article is then ink-printable. i.e. the printing withstands rubbing or abrasion that might be encountered in the use of the article. For example, when the article is cable jacket, the cable containing the jacket can be handled for installation without significantly diminishing the legibility of the printing. The same is true for the environment in which the cable is installed, e.g. as plenum cable in buildings. Thus, the process of the present invention can also be described as comprising melt-fabricating an article comprising perfluoropolymer and about 10 to 60 wt % of inorganic particulate filler and ink printing on the surface of said article.

There are preferred characteristics of the perfluoropolymer/filler composition from which the printable surface is formed.

The particulate filler is preferably of very small particle size so that the melt-fabricated article will have a smooth surface. In a preferred embodiment, the mean particle size of the particulate filler is no greater than about 5 μm, preferably no greater than about 3 μm.

In another preferred embodiment, the amount of particulate filler is about 20 to 50 wt %. In addition, the particulate filler is preferably a char-forming agent, so that the article fabricated from the perfluoropolymer/filler composition passes the NFPA-255 burn test (Surface Burning Characteristics of Building Materials). This burn test is more strict that the older burn test, UL-910 (NFPA-262). UL 2424, Appendix A, provides that electrical cables tested in accordance with NFPA-255 must have a smoke developed index (hereinafter Smoke Index) of no greater than 50 and a flame spread index (Flame Spread Index) of no greater than 25. The char-forming agent forms a char when the fabricated article such as plenum cable, which includes a jacket for the insulated wires of the cable, is subjected to the NFPA-255 burn test.

The addition of large amounts of filler, even when the filler is char-forming agent, increases the difficulty in extruding the resultant composition to form the fabricated article desired, resulting in a loss of productivity, and causes a reduction in tensile properties, as determined by such tensile tests as tensile strength and elongation. Unfortunately, to provide for the char-formation that enables the article to pass the NFPA-255 burn test, large amounts of char-forming agent are required. This problem is solved by the preferred embodiment of incorporating hydrocarbon polymer into the perfluoropolymer/filler composition so that the fabricated article to be subjected to ink printing contains all three components. The hydrocarbon polymer improves the dispersion of the particulate filler in the perfluoropolymer and enables the resultant composition to be extruded without loss of productivity and to possess satisfactory physical properties. The hydrocarbon polymer is used in a small amount which is effective to improve the dispersion of the filler particles in the perfluoropolymer to produce a smooth, strong extruded article that is ink-printable.

Another embodiment of the present invention is the perfluoropolymer/filler composition, preferably containing hydrocarbon polymer, which forms the melt-fabricated article, such as plenum cable jacket, that is ink-printable.

### DETAILED DESCRIPTION OF THE INVENTION

The perfluoropolymers used to form the ink-printable surface in accordance with the present invention are those that are melt-fabricable, i.e. they are sufficiently flowable in the molten state that they can be fabricated by melt processing such as extrusion, to produce products having sufficient strength so as to be useful. The melt flow rate (MFR) of the perfluoropolymers used in the present invention is relatively high, preferably at least about 10 g/10 min, more preferably at least about 15 g/10 min, and even preferably at least about 20 g/10 and most preferably at least about 26 g/10 min, as measured according to ASTM D-1238 at the temperature which is standard for the resin (see for example ASTM D 2116-91a and ASTM D 3307-93). The relatively high MFR of the perfluoropolymers prevent them when used alone as cable jacket from passing the NFPA-255 burn test. It is characteristic of the perfluoropolymers, as indicated by the prefix “per”, that the monovalent atoms bonded to the carbon atoms making up the polymer are all fluorine atoms. Other atoms may be present in the polymer end groups, i.e. the groups that terminate the polymer chains. Examples of perfluoropolymers that can be used in the composition of the present invention include the copolymers of tetrafluoroethylene (TFE) with one or more perfluorinated polymerizable comonomers, such as perfluoroolefin having 3 to 8 carbon atoms, such as hexafluoropropylene (HFP), and/or perfluoro(alkyl vinyl ether) (PAVE) in which the linear or branched alkyl group contains 1 to 5 carbon atoms. Preferred PAVE monomers are those in which the alkyl group contains 1, 2, 3 or 4 carbon atoms, respectively known as perfluoro(methyl vinyl ether) (PMVE), perfluoro(ethyl vinyl ether) (PEVE), perfluoro(propyl vinyl ether) (PPVE), and perfluoro(butyl vinyl ether) (PBVE). The copolymer can be made using several PAVE monomers, such as the TFE/perfluoro(methyl vinyl ether)/perfluoro(propyl vinyl ether) copolymer, sometimes called MFA by the manufacturer. The preferred perfluoropolymers are TFE/HFP copolymer in which the HFP content is about 9-17 wt %, more preferably TFE/HFP/PAVE such as PEVE or PPVE, wherein the HFP content is about 9-17 wt % and the PAVE content, preferably PEVE, is about 0.2 to 3 wt %, to total 100 wt % for the copolymer. These polymers are commonly known as FEP. TFE/PAVE copolymers, generally known as PFA, have at least about 1 wt % PAVE, including when the PAVE is PEVE or PPVE and will typically contain about 1 to 15 wt % PAVE. When PAVE includes PMVE, the composition is about 0.5-13 wt % perfluoro(methyl vinyl ether) and about 0.5 to 3 wt % PPVE, the remainder to total 100 wt % being TFE, and as stated above, may be referred to as MFA.

The composition of the present invention is highly filled, the inorganic particulate filler constituting at least about 10 to 60 wt % of the composition (total weight of perfluoropolymer plus filler). The amount of filler desired will depend on its intended purpose. For example, the filler can be a char-forming agent that forms a char when the article molded from the composition is subjected to burning. A preferred utility of the composition used in the present invention is as a cable jacket for plenum cable, which is cable used for data and voice transmission that is installed in building plenums, i.e. the spaces above dropped ceilings or below raised floors that are used to return air to conditioning equipment. The cable comprises a core which performs the transmission function and a jacket over the core. Typical core constructions include a plurality of twisted pairs of insulated wires or coaxially-positioned insulated conductors.

The char-forming agent is present in the composition forming the jacket in a sufficient amount that enables the cable to pass the NFPA-255 burn test (Surface Burning of Building Materials), i.e. to exhibit a smoke developed index (Smoke Index) of no greater than 50 and a flame spread index (Flame Spread Index) of no greater than 25 in accordance with Appendix A of UL-2424. In the burn test, the agent does not prevent the perfluoropolymer from burning, because the fluoropolymer is not flammable in this burn test, i.e. it has a Flame Spread Index of no greater than 25. Instead, the agent contributes to formation of a char structure that prevents the total composition from dripping, which would lead to objectionable smoke formation (Smoke Index exceeding 50) and failure of the burn test. The amount of char-forming agent necessary for the jacket to pass this test will depend on the effectiveness of the particular agent used, the particular perfluoropolymer used, and its MFR. Although the perfluoropolymer does not burn (Flame Spread Index no greater than 25), it appears that the char-forming agent interacts with the perfluoropolymer during the burn test to prevent the high MFR perfluoropolymer from dripping, whereby the creation of smoke is suppressed. Although the combination of the perfluoropolymer and char-forming agent is melt flowable (extrudable), which suggests that the composition would drip when subjected to burning, the composition resists dripping. Some agents are more effective than others, whereby a relatively small amount of agent will suffice. The filler, whether it be a char-forming agent or just contributes to the extrudability of the composition or both, can be a single filler or a mixture thereof. Generally, sufficient char or other desired property can be obtained when the composition contains at least about 20 wt % of the char-forming agent and no more than about 50 wt % of the char-forming agent, the remainder to total 100 wt % being the perfluoropolymer. Examples of fillers including char-forming agents, are zinc molybdate, calcium molybdate, metal oxides such as ZnO, Al₂O₃, TiO₂ and MgZnO₂. Another example of filler, which is also a char-forming agent, is ceramic microspheres, such as Zeeospheres® ceramic microspheres available from the 3M Company, which are understood to be alkali alumina silicates. Preferably, the amount of filler in the composition will be about 20 to 50 wt % (perfluoropolymer, filler, hydrocarbon polymer). Preferably the mean particle size of the filler is no greater than about 5 μm, more preferably no greater than about 3 μm, and even more preferably, no greater than about 1 μm, to provide the best physical properties for the composition. It is also preferred that the mean minimum particle size is at least about 0.05 μm; smaller particle sizes tend to embrittle the composition. In one embodiment of the present invention, the filler comprises a plurality of fillers, e.g. a plurality of char-forming agents. In another embodiment of the present invention, at least one of this plurality of fillers is ceramic microspheres. The presence of ceramic microspheres in the composition improves the, printability of the surface of the article made from the composition. A preferred composition comprises about 5 to 20 wt % ceramic microspheres and about 20-40 wt % of another filler, preferably a char-forming agent, more preferably ZnO, to constitute the about 10-60 wt % filler component of the composition to be melt fabricated into an article, the surface of which is to be ink printed in accordance with the present invention.

The particulate filler, even when it is a char-forming agent, is thermally stable and non-reactive at the melt processing temperature of the composition, in the sense that it does not cause discoloration or foaming of the composition, which would indicate the presence of degradation or reaction. The agent itself has color, typically white, which provides the color of the melt-processed composition. In the burn test however, the formation of char indicates the presence of degradation.

The perfluoropolymer and filler are mixed together by melt blending; i.e. the perfluoropolymer is in the molten state and is subjected to shear to enable the filler to be incorporated into the perfluoropolymer. The higher the proportion of filler and/or the larger its particle sizes, the more difficult is this incorporation. Lack of complete incorporation is indicated by the resultant melt blend having a “cheesy” appearance, i.e. the melt blend has the appearance of fissures and cracks, and some unincorporated filler may also be present. A smooth, fissure-free melt blend having a uniform color is an appearance that suggests improved incorporation of the char-forming agent into the perfluoropolymer.

According to a preferred embodiment of the present invention, hydrocarbon polymer is melt blended with the perfluoropolymer/filler combination and surprisingly, aids in the incorporation of the filler into the perfluoropolymer. The filler when melt blended with the perfluoropolymer by itself produces a melt blend which when fabricated into articles has reduced tensile properties, such as reduced tensile strength and/or elongation. The hydrocarbon polymer is used in an amount that is effective to provide the physical properties desired and to incorporate the filler into the perfluoropolymer. The hydrocarbon polymer itself does not provide the improved physical properties. Instead, the hydrocarbon polymer interacts with the filler and perfluoropolymer to limit the reduction in tensile properties that the filler if used by itself would have on the perfluoropolymer composition. As stated above, without the presence of the hydrocarbon polymer, the melt blend of the perfluoropolymer/filler tends to be cheesy in appearance, i.e. to lack integrity, e.g. showing cracks and containing loose unincorporated filler. With the hydrocarbon polymer being present, a uniform-appearing melt blend is obtained, in which the entire char-forming agent is incorporated into the melt blend. Thus, the hydrocarbon polymer appears to act as a dispersing agent for the filler, which is surprising in view of the incompatibility of the perfluoropolymer and hydrocarbon polymer. Hydrocarbon polymer does not adhere to perfluoropolymer. Neither does the filler. Nevertheless and surprisingly, the hydrocarbon polymer acts as a dispersing agent for the filler. The effectiveness of the dispersion effect of the hydrocarbon polymer can be characterized by the tensile test specimen of the composition exhibiting an elongation of at least about 100%, preferably at least about 150%. The specimen also preferably exhibits a tensile strength of at least about 1500 psi (10.3 MPa). Preferably these properties are achieved on cable jacket specimens in accordance with ASTM D 3032 under the operating conditions of the tensile testing jaws being 2 in (5.1 cm) apart and moving apart at the rate of 20 in/min (51 cm/min). The foregoing and following description of the amount of filler and the effect of the hydrocarbon polymer on the filler is applicable to the filler when it is char-forming agent.

A wide variety of hydrocarbon polymers that are thermally stable at the melt temperature of the perfluoropolymer, provide this benefit to the composition. The thermal stability of the hydrocarbon polymer is visualized from the appearance of the melt blend of the composition, that it is not discolored or foamed by degraded hydrocarbon polymer. Since perfluoropolymers melt at temperatures of at least about 250° C., the hydrocarbon polymer should be thermally stable at least up to this temperature and up to the higher melt processing temperature, which will depend on the melting temperature of the particular perfluoropolymer being used and the residence time in melt processing. Such thermally stable polymers can be semicrystalline or amorphous, and can contain aromatic groups either in the polymer chain or as pendant groups. Examples of such polymers include polyolefins such as the linear and branched polyethylenes, including high density polyethylene and Engage® polyolefin thermoplastic elastomer and polypropylene. Additional polymers include siloxane/polyetherimide block copolymer. Examples of aromatic hydrocarbon polymers include polystyrene, polycarbonate, polyethersulfone, and polyphenylene oxide, wherein the aromatic moiety is in the polymer chain. The preferred polymer is a thermoplastic elastomer, which is a block copolymer of olefin units and units containing an aromatic group, commonly available as Kraton® thermoplastic elastomer. Most preferred are the Kraton® G1651 and G1652 that are styrene/ethylene/butylene/styrene block copolymers containing at least 25 wt % styrene-derived units. The hydrocarbon polymer should have a melting temperature or be melt flowable in the case of amorphous hydrocarbon polymers so as to be melt-blendable with the other ingredients of the composition.

The amount of hydrocarbon polymer necessary to provide beneficial effect in the composition will generally be about 0.1 to 5 wt % (based on total weight of the perfluoropolymer, filler and hydrocarbon polymer), depending on the amount of filler that is present in the composition. Preferably the amount of such polymer present is about 0.5 to 3 wt %, based on the total weight of perfluoropolymer, filler and hydrocarbon polymer. In the composition, the preferred amount of filler is about 20 to 50 wt % based on the total weight of the perfluoropolymer, filler, and hydrocarbon polymer. Thus, the preferred composition used to form a printable article according to the present invention consists essentially of about 10 to 60 wt % filler, preferably about 20 to 50 wt % thereof, about 0.1 to 5 wt % hydrocarbon polymer, preferably about 0.5 to 3 wt % thereof, and the remainder to total 100 wt % being perfluoropolymer.

The composition forming the ink-printable article of the present invention will typically start as a physical mixture of the components, which is then melt blended to disperse the filler in the perfluoropolymer. This melt blending can be part of the melt-fabrication process to produce the final article, e.g. using an extruder that also accomplishes the melt blending prior to the extrusion. Alternatively, the composition can be exposed to two melt blending processes, the first forming molding pellets, each containing all the components of the composition, and the second being the melt fabrication of the molding pellets, such as by extrusion, to produce the desired final article. Typically, the two-melt blending process approach will be followed because of the flexibility it provides in choice of extrusion equipment for the extrusion practitioner. First, the composition is melt blended, such as by using a twin-screw extruder or Buss Kneader® compounding machine, to form molding pellets, each containing all two or three ingredients of the composition, depending on the embodiment of the article being prepared. The molding pellets are a convenient form for feeding to melt processing equipment such as for extruding the composition into the fabricated article desired, such as jacket for (on) plenum cable. The Buss Kneader® operates by melting the polymer components of the composition and shearing the molten composition to obtain the incorporation of the filler into the perfluoropolymer, preferably with the aid of the hydrocarbon polymer. The residence time of the composition in this type of melt processing equipment may be longer than the residence time in extrusion equipment. To avoid degradation, the Buss Kneader® is operated at the lowest temperature possible consistent with good blending, barely above the melting temperature of the perfluoropolymer, while the extrusion temperature can be considerably higher because of the shorter residence time in the extruder.

The melt blended pelletized composition is especially useful for making the jacket of twisted pair (insulated wires) cable, wherein such cable passes the NFPA-255 burn test. The most common such cable will contain four twisted pairs of insulated wires, but the jacket can also be applied to form cable of many more twisted pairs of insulated wires, e.g. 25 twisted pairs, and even cable containing more than 100 twisted pairs. It is preferred that the wire insulation of the twisted pairs be also made of perfluoropolymer. It has been found that when the entire insulation is replaced by polyolefin, the jacketed cable fails the NFPA-255 burn test.

Jacket made of perfluoropolymer by itself that passes the NFPA burn test has a low melt flow rate, such as about 2-7 g/10 min, which for jacketing four twisted pairs of insulated wires, is limited to a very low line speed in the extrusion/jacket operation, of about 100 ft/min (30.5 m/min). Cable jackets made according to the present invention enable printed images of greater durability to be formed. Notwithstanding the high filler (char-forming agent) content of the composition, it can be extruded as cable jacket at line speeds of at least about 300 ft/min (91.5 m/min), preferably at about 400 ft/min (122 m/min) when the hydrocarbon polymer is present in the melt blend. Line speed is the windup rate for the cable, which is also the speed of the assemblage of twisted pairs fed through the extruder crosshead to receive the jacket. The rate of extrusion of molten composition is less than the line speed, with the difference in speeds being made up by the draw down ratio of the extruded tube of molten composition drawn down in a conical shape to contact the assemblage of insulated wires. Draw down ratio is the ratio of the annular cross section of the extrusion die opening to the annular cross section of the jacket.

The preferred ink-printable composition (perfluoropolymer, filler, hydrocarbon polymer), while capable of high speed cable jacketing, also produces a smooth jacket, which maintains the positioning the twisted pairs within the jacket, but does not adversely affect electrical properties such as the attenuation of the data signal by the cable. The uneven topography (outer surface) of the twisted pairs within the cable should be barely to not at all visible from the exterior of the cable, whereby the outside of the jacket has a smooth appearance, not conforming to the topography of the core of twisted pairs of insulated wires. Sometimes this is referred to as a “loose fit” but the fit of the jacket over the twisted pairs is snug enough that the jacket does not slide over the surface of the twisted pairs to form wrinkles in the jacket. Articles other than cable jacketing can be advantageously melt fabricated from compositions used in the the present invention, these articles too passing the NFPA-255 burn test. Examples of such articles include tubing, especially conduit (raceway) for data and voice transmission cable, profiles (spacers) for twisted pair cables, and tape for bundling cables.

The ink-printing of the article, such as cable jacket can be done in-line with the extrusion operation forming the article, by using conventional ink jet printing. The receptivity of the article surface for the ink can be improved by treating the surface of the article immediately preceding the printing, by such heat treatment as exposure of the article to flame or heat gun or by plasma exposure. Following the ink printing, the abrasion resistance of the ink may be improved by additional heat treatment applied to the printed image immediately after printing, such as exposure of the printed image to flame or heat gun. The ink itself can be heat settable, so the flame treatment sets (toughens) the printed image.

In another embodiment of the present invention, the composition to be melt fabricated into an ink-printable article in accordance with the present invention further comprises an inorganic phosphor in an effective amount to color said composition when subjected to excitation radiation. The phosphor also similarly colors the article melt fabricated from the composition so that the manufacturing source of the composition from which the article is made is detectible. U.S. Pat. No. 5,888,424 discloses the incorporation of inorganic phosphor into colorant-free fluoroplastics in very small amounts, up to 450 ppm. The phosphor typically comprises an inorganic salt or oxide plus an activator, the combination of which is sensitive to exposure to radiation in the 200-400 nm wavelength region causing fluorescence in the visible or infrared wavelength region. This fluorescence, constituting emitted radiation, gives a colored appearance to the composition or article made therefrom, which is characteristic of the phosphor. The phosphors disclosed in the '424 patent are useful in the present invention, except that a greater amount is required for the colored appearance to be seen. Thus, in accordance with this embodiment, the amount of phosphor is about 0.1 to 5 wt %, preferably about 0.5 to 2 wt %, based on the combined weight of perfluoropolymer, filler, and phosphor. These amounts of phosphor also apply to the composition when it contains hydrocarbon polymer. By way of example, the composition of Example 12 is supplemented with 0.5 to 1 wt % of ZnS/Cu:Al phosphor by dry mixing of the phosphor with the other jacket ingredients prior to extrusion, and the resultant jacket when subjected to ultraviolet light of 365 nm wavelength, gives a green appearance to the jacket in the visible wavelength region. When the ultra-violet light source is turned off, the jacket returns to its original white appearance. It will be noted that the phosphor of Example 30 of the '424 patent includes ZnO, which is the inorganic char-forming agent (filler) in the aforesaid Example 12. When this particular filler is used, an activator such as the Zn of Example 30 of the '424 patent is all that need be added to the extrusion composition to obtain a similar phosphor effect, i.e. fluorescence to produce a green color. Thus, in another embodiment of the present invention, when the filler has the ability to become a phosphor when suitably activated, an effective amount of such activator is added to the composition to produce the phosphor effect.

### EXAMPLES

In the Examples below, the three-components: perfluoropolymer, hydrocarbon polymer, and inorganic char-forming compound are melt blended together by the following general procedure: The perfluoropolymer compositions are prepared using a 70 millimeter diameter Buss Kneader® continuous compounder and pelletizer. A Buss Kneader® is a single reciprocating screw extruder with mixing pins along the barrel wall and slotted screw elements. The extruder is heated to temperatures sufficient to melt the polymers when conveyed along the screw. All ingredients are gravimetrically fed into the Buss Kneader® from one or more of the multiple feed ports along the barrel. The Buss Kneader® mixes all the ingredients into a homogeneous compound melt. The homogeneous compound melt is fed into a heated cross-head extruder and pelletized. The description of the compositions in terms of “parts” refers to parts by weight unless otherwise indicated.

The general procedure for forming a jacket of the melt blended composition involves extruding the blend as a jacket over a core of four twisted pairs of FEP-insulated wires to form jacketed cable, using the following extrusion conditions: The extruder has a 60 mm diameter barrel, L/D of 30:1, and is equipped with a metering type of screw having a compression ratio with the respect to the barrel of about 3:1 as between the feed section of the screw and the metering section, i.e. the free volume, that is the volume in the extruder barrel that is unoccupied by the screw, wherein the screw flights in the feed section are about 3× the volume within the screw flights within the metering section. For a screw of constant pitch, the compression ratio is the ratio of the flight depth in the feed section to the flight depth in the metering section (metering into the crosshead). The application of heat to the extruder barrel starts with 530° F. (277° C.) in the feed section, increasing to 560° F. (293° C.) in the transition section and then to 570° F. (298° C.) in the metering section. The extruder is fitted with a B&H 75 crosshead. The assemblage of four twisted pairs of FEP-insulated wires is fed though the cross-head and out the die tip of the crosshead. The temperature of the molten fluoropolymer at the die surrounding the die tip is 598° F. (314° C.). The outer diameter of the die tip is 0.483 in (12.3 mm) and the inner diameter of the die is 0.587 in (14.9 mm), with the annular space between the die tip and the I.D. of the die forming the annular space through which a molten tube of FEP is extruded and drawn down to coat the assemblage of twisted pairs of insulated wire. No vacuum is used to draw the extruded tube down onto the core of twisted pairs of insulated wires. The draw down ratio is 10:1, the thickness of the jacket being 10 mils (0.25 mm), and the draw ratio balance is 0.99. Draw ratio balance is the draw ratio of the molten polymer at the I.D. of the die vs. the draw ratio of the molten polymer at the die tip. The line speed is 403 ft/min (123 m/min).

The ink-jet printer head for ink-printing on the extruded jacket is located 15 ft (4.6 m) from the extrusion crosshead. The jacket is exposed to plasma treatment before printing, using a model PT 1000 plasma equipment from Tri-Star Technologies, operating at about 70% power. The ink used is number XBS04043 obtained from Gem Gravure. The printed image is also flame treated after printing.

The fire test chamber (elongated furnace) and procedure set forth in NFPA-255 is used to expose 25 ft (7.6 m) lengths of cable to burning along 5 ft (1.5 m) of the 25 ft length (7.6 m) of the furnace, the furnace being operated according to the instructions set out in NFPA-255. The lengths of cable for testing are placed in side-by-side contact with one another so as to fill the test space above the burner of the furnace with a bed of single thickness cable, and the cable is supported by metal rods spanning the furnace and spaced one foot (30.5 cm) apart along the length of the furnace and the length of the cables. Additional support for the cables is provided by steel poultry netting, such as chicken wire, the poultry netting laying on the metal rods and the cable laying on the poultry netting, as set forth in Appendix B-7.2. A large number of cables, each 25 ft (7.6 m) long, are laid on the poultry netting as described above, such that for the common 4-pair twisted cable, having a jacket thickness of about 10 mils (0.25 mm), more than 100 cables, each 25 ft (7.6 m) long, are tested at one time.

The Flame Spread Index is determined in accordance with Chapter 3, Appendix A of NFPA-255.

The Smoke Index is determined using the smoke measurement system described in NFPA-262 positioned in an exhaust extension of the furnace in which the burn test is conducted. The smoke measurement system includes a photoelectric cell, which detects and quantifies the smoke emitted by the cable jacket during the 10-minute period of the burn test. The software associated with the photoelectric cell reports the % obscuration in the exhaust stream from the furnace in the ten-minute period, and the area under the % obscuration/time curve is the Smoke Index (see NFPA-255, Appendix A, 3-3.4 for the determination of Smoke Index). The Flame Spread Index and Smoke Index are determined on as is lengths of cable, i.e. without slitting the jacket lengthwise or without first exposing the cable to accelerated aging. The chemical stability of FEP enables the tensile and burn results after aging at 158° C. for seven days to be about as good as the results before aging.

The FEP used as the primary insulation on the twisted pairs of wires used in the Examples has an MFR of 28 g/10 min and contains PEVE comonomer as described in U.S. Pat. No. 5,677,404. The same FEP is used in the jacket composition in the following Examples unless otherwise specified.

### Comparative Example

A jacket of just the FEP fails the NFPA-255 burn test. The ink-printed image on the jacket rubs off with just rubbing by a thumb. Tensile testing of compression molded plaques (ASTM D 638) of the FEP results in good tensile strength and elongation of 3259 psi (22.5 MPa) and 350%, respectively.

A jacket of the FEP and Kraton® block copolymer elastomer (1 wt %) fails the NFPA-255 burn test. The ink-printed image on the jacket rubs off by rubbing with a thumb.

In this following Examples of the present invention, a number of compositions are described, each containing FEP, filler as char-forming agent, and hydrocarbon polymer, each forming test articles exhibiting good physical and electrical properties, and each capable of being extruded at a line speed exceeding 300 ft/min (91.5 m/min) at the low melt temperature specified above as a jacket over twisted pairs of insulated wires, with the resultant jacketed cable passing the NFPA-255 burn test and being ink-printable as described above. The jacket formed of each of the compositions is printed, with before and after treatment as described above, and the resultant printed image is legible and durable. Durability is established by rubbing of the printed image with a thumb or by scraping of the image with a fingernail or both without appreciably affecting the legibility of the printed image. Similar results are obtained when the FEP is replaced in part or entirely by other perfluoropolymers.

### Example 1

The composition 100 parts of FEP, 3.5 parts Kraton® G1651 thermoplastic elastomer, and 30 parts calcium molybdate, mean particle size less than 1 μm, to total 133.5 parts by weight, is melt blended and then extruded. Tape samples tested in accordance with ASTM D 412 (5.1 cm/min) exhibit a tensile strength of 1460 psi (10.1 MPa) and elongation of 150. Test samples also exhibit good electrical and nonflammability properties, as follows: dielectric constant of 2.64 and dissipation factor of 0.004 (ASTM D 150) and an limiting oxygen index (LOI) of greater than 100% (0.125 in sample (3.2 mm)). The lower the dielectric constant, the better; generally a dielectric constant of no greater than 4.0 is considered satisfactory. These test procedures are used in the succeeding Examples unless otherwise indicated.

### Example 2

The composition 100 part FEP, 30 parts Kadox® 920 ZnO mean particle size 0.2 μm, and 3.5 parts Kraton® G1651 thermoplastic elastomer is melt blended and extruded. Tape samples exhibit the following properties: tensile strength 1730 psi (11.9 MPa) and elongation 225%. Test samples also exhibit good electricals and nonflammability: dielectric constant of 2.5, dissipation factor of 0.007, and LOI of greater than 100%.

### Example 3

The composition of 100 parts FEP, 3.5 parts Kraton® G1651, 30 parts ZnO (Kadox® 920), and 5 parts calcium molybdate is melt blended and extruded. Tape samples exhibit tensile strength of 1792 psi (12.3 MPa) and elongation of 212%. Dielectric constant is 2.72, dissipation factor is 0.011 and LOI is greater than 100%.

### Example 4

The composition of 100 parts FEP, 1 part Kraton®, and 66.66 parts of Onguard® 2 (MgZnO₂) is melt blended and extruded to give good extrudate, i.e. smooth to form a tough jacket.

### Example 5

The composition 100 parts FEP, 5 parts Engage® polyolefin, and 20 parts Mg(OH)₂/zinc molybdate (Kemguard® MZM) is melt blended and extruded, and its test samples exhibit tensile strength of 1850 psi (12.8 MPa), elongation of 153% and LOI of 91%.

### Example 6

The composition 100 parts FEP, 1.5 parts Kraton® G1651 and 75 parts Cerox® 502 ZnO, mean particle size of 2.2 μm, is melt blended and extruded to give good extrudate. Tensile testing on rod samples (51 cm/min) gives tensile strength of 2240 psi (15.4 MPa) and elongation of 215%.

### Example 7

The composition of 100 parts FEP, 3 parts DGDL3364 (Dow Chemical) high density polyethylene, and 75 parts Cerox® 506 ZnO is melt blended and extruded to give good extrudate. Test rods exhibit tensile strength of 1830 psi (12.6 MPa) and elongation of 110%, which is good for rod samples.

### Example 8

The composition of 100 parts FEP, 2.5 parts Siltem® 1500 (dried) (siloxane/polyetherimide) block copolymer, and 75 parts Cerox® 506 ZnO is melt blended and extruded to give good extrudate. Test rods exhibit tensile strength 1700 psi (11.7 MPa) and 170% elongation.

### Example 9

The composition 100 parts FEP, 5 parts Lexan® 141 polycarbonate, 5 parts Kraton® G1651 elastomer, and 50 parts Cerox® 506 ZnO is melt blended and extruded to give good quality extrudate. Rod test samples exhibit tensile strength of 2245 psi (15.5 MPa) and 300% elongation.

### Example 10

The composition of 100 parts FEP, 1 part Lexan® 141 polycarbonate, and 75 parts Cerox® 506 ZnO is melt blended and extruded to give good quality extrudate.

### Example 11

The composition of 68 wt % FEP, 2 wt % Kraton® G1651 thermoplastic elastomer, and 30 wt % Al₂O₃ is melt blended and tested for MFR, which is better for the composition (32.3 g/10 min) than the FEP by itself (MFR 31.125 g/10 min). The composition gives good extrudate.

### Example 12

A jacket having the following composition: FEP 100 parts, aromatic hydrocarbon elastomer (Kraton® G1651) 1 part per hundred parts (pph) FEP, and 66.66 pph Kadox® 930 ZnO (mean particle size 0.33 μm) (total weight of composition is 176.66 parts), is formed. The jacket has a wall thickness of 9-10 mil (0.23-0.25 mm) and the overall cable has a diameter of 0.166 in (4.2 mm) and forms a snug fit (exhibiting a cylindrical appearance, not conforming to the topography of the core twisted pairs of insulated wires) over the 4 twisted pairs of insulated wire in the cable. 121 lengths of this cable are simultaneously subjected to the burn test under NFPA-255, with the result being a Flame Spread Index of 0 and a Smoke Index of 29. The surface of the jacket is smooth and the tensile strength and elongation rod samples of the composition are 2235 psi (15.4 MPa) and 165%, respectively. The tensile properties of the jacket itself are tested in accordance with ASTM D 3032, wherein a length of jacket is cut circumferentially and is slipped off the cable to form the test specimen. The test conditions are a spacing of 2 in (5.1 cm) between the tensile tester jaws, and the jaws being pulled apart at the rate of 20 in/min (51 cm/min). The jacket specimen so-tested exhibits a tensile strength of 2143 psi (14.8 MPa) and elongation of 301%. The jacket also exhibits a dielectric constant at 100 MHz of 3.32. When the burn test is repeated on this cable after aging at 158° C. for 7 days, it exhibits a Flame Spread Index of 0 and Smoke Index of 25.

### Example 13

The NFPA-255 burn test is carried out on a cable wherein the jacket has the following composition: 100 parts FEP, 3.5 pph Kraton® 1551G, and 100 pph Cerox®-506 ZnO (mean particle size less than 1 μm), to total 203.5 parts. The jacket wall thickness varies from 7-13 mils (0.18-0.33 mm) and the cable thickness is 0.186 in (4.7 mm). 108 cable lengths are tested in the burn test, and the result is Flame Spread Index of 0 and Smoke Index of 23.

### Example 14

Similar results to Example 12 are obtained when the jacket composition is 100 parts FEP, 2.6 pph Kraton® G1651, and 75 pph Cerox® 506 ZnO, to total 177.6 parts, and the jacket wall thickness is 10 mil (0.25 mm) and the cable diameter is 0.186 in (4.7 mm). 108 lengths of the cable are tested in the NFPA-255 burn test, and the results are Flame Spread Index of 0 and Smoke Index of 30.

### Example 15

Results similar to Example 12 are obtained when the jacket composition is as follows: 100 parts FEP, 3.5 pph Kraton® G1651, and 50 pph Cerox® 506 ZnO, to total 153.5 parts, and the jacket wall thickness is 8 mils (0.2 mm) and the cable diameter is 0.156 in (4 mm). 129 lengths of cable are tested in the NFPA-255 burn test, and the results are Flame Spread Index of 0 and Smoke Index of 25. The jacket also exhibits a dielectric constant of 3.6 at 100 MHz.

### Example 16

Results similar to Example 12 are obtained when the jacket composition is: 100 parts FEP, 3.5 pph Kraton® G1651, and 30 pph Kadox® 920 ZnO, to total 133.5 parts, and the jacket wall thickness is 7 mils (0.18 mm) and the cable diameter is 0.169 in (4.3 mm). 119 lengths of cable are tested in the NFPA-255 burn test and the results are Flame Spread Index of 0 and Smoke Index of 40.

### Example 17

The general melt-blending procedure is applied to a two-component composition in this Example. A composition of FEP and 30 wt % ZnO (Kadox® 930), to total 100 wt %, reduces the MFR of the FEP to 20-22 g/10 min, and compression molded plaques exhibit less than desired tensile properties: tensile strength of 1536 psi and elongation of only 106%. These properties are improved by using less ZnO in the composition, and the reduced concentration of the ZnO is still sufficient for the jacket made from the composition to pass the NFPA-255 burn test.

### Example 18

In this Example, the composition of Example 12 is varied by replacing some of the Kadox® 930 ZnO by Zeeospheres® ceramic microspheres W-210 having a mean particle size of 3 μm, and the composition is extruded as a smooth jacket to form coaxial cable comprising a central copper conductor, a foamed plastic insulation, a metal braid surrounding the foamed insulation, and the jacket.

In one extrusion run, the jacket composition has only 46.7 parts of Kadox® per hundred parts of FEP and has 20.0 parts per hundred of the ceramic microspheres (11.93 wt % of the composition). In another extrusion run, the same proportion of ceramic microspheres is present, but the Kraton® is replaced by the same amount of Siltem® 1500. In another extrusion run, the ceramic microspheres content is decreased to 10 parts per hundred parts of FEP and the same hydrocarbon polymer (Siltem® 1500) is used, the proportion of ceramic microspheres in this composition being 5.96 wt %. All of these jacket compositions provide an advantage over the Example 12 composition in exhibiting no spark faults in wire line testing applying a voltage of 3000V to the jacket at a line speed of about 53 m/min for at least 2 min. The jacket for coaxial cable is prone to spark faults because of the underlying metal braid. Use of the ceramic microspheres to constitute at least part of the char-forming agent in the jacket eliminates spark faults. Use of the ceramic microspheres also improves the ink printability of the jacket, as manifested by a brighter printed image as compared to the printed image on the jacket of Example 12.

In still another extrusion run, the jacket composition contains less Kadox® than Example 12, i.e. 50 parts per hundred parts of FEP 1.0 part of Siltem® 1500 instead of the 1 part of Kraton®, and additionally 2.5 parts of Aerosil® R-972 fumed silica per 100 parts of FEP. This jacket too exhibits no spark faults.

All of these jacket compositions are also applied as a jacket over four twisted pairs of insulated wire for comparison of the burn/smoke generation performance (NFPA-255) with the jacket of Example 13, and these jacket compositions perform as well as the Example 13 jacket in this regard.

1. Process comprising ink printing on the surface of an article melt-fabricated from perfluoropolymer, and incorporating into said perfluoropolymer prior to said printing from about 10 to 60 wt % of inorganic particulate filler.

2. The process of claim 1 wherein the mean particle size of said particulate filler is no greater than about 5 micrometers.

3. The process of claim 1 wherein at least about 20 wt % of said particulate filler is present.

4. The process of claim 1 wherein said filler is char-forming agent.

5. The process of claim 1 wherein hydrocarbon polymer is also incorporated into said copolymer to disperse said particulate filler in said copolymer during the melt blending thereof either during said melt-fabrication or prior thereto.

6. The process of claim 1 wherein said article is cable jacket.

7. The process of claim 5 wherein said cable jacket is on plenum cable.

8. The process of claim 1 wherein said filler comprises a plurality of fillers.

9. The process of claim 8 wherein one of said plurality of fillers is ceramic microspheres.

10. The process of claim 9 wherein said from 5 to 20 wt % of said ceramic microspheres are present, the remainder of said filler constituting said 10 to 60 wt % being another said filler different from said ceramic microspheres.

11. Process comprising melt-fabricating an article comprising perfluoropolymer and about 10 to 60 wt % of inorganic particulate filler and ink printing on the surface of said article.
